(19) United States
(12) Patent Application Publication
(10) Pub. No.: US 2026/0031068 A1
(43) Pub. Date: Jan. 29, 2026

(54) TRUMPET THUMB GUIDE

(71) Applicant: Geoffrey Richards, Superior, CO (US)

(72) Inventor: Geoffrey Richards, Superior, CO (US)

(21) Appl. No.: 18/970,839

(22) Filed: Dec. 5, 2024

Related U.S. Application Data
(60) Provisional application No. 63/676,623, filed on Jul. 29, 2024.

(51) Int. Cl. G10D 9/00

(52) U.S. Cl. CPC G10D 9/00

(57) ABSTRACT

A thumb guide for aiding in proper hand position while holding a trumpet-like instrument is disclosed. The thumb guide includes a main body having a slot to receive a leadpipe of a trumpet-like instrument. A channel is positioned along a central axis of the main body to retain the leadpipe of the trumpet therein. A recessed portion promotes the ergonomic positioning of a thumb and a hand of a user while playing the trumpet-like instrument.

### CROSS-REFERENCE TO RELATED APPLICATIONS

The present application claims priority to U.S. Provisional Application No. 63/676,623 filed Jul. 29, 2024, titled “TRUMPET RIGHT HAND THUMB GUIDE,” which is hereby incorporated by reference in its entirety.

### TECHNICAL FIELD

The embodiments generally relate to devices for aiding in playing musical instruments, and more specifically to a thumb guide for use while holding and playing a trumpet.

### BACKGROUND

Instruments, including trumpets, flugelhorns, cornets, etc, are commonly used in musical ensembles and for the general enjoyment of learning and playing an instrument. Sound is produced by vibrating the lips in a mouthpiece which starts a standing wave in the air column of the instrument. Modern trumpet-like instruments include a means for changing the length of tubing which often includes multiple valves which are pressed to alter the pitch being produced. In some instruments, a tuning slide is included to further raise and lower the pitch.

Musical instruments are notoriously difficult to learn to play well and can take a years to become proficient as they require precise implementation of movements and techniques. For example, trumpet-type instruments require the coordination of the hands and fingers which operate the functional elements of the instrument to produce the desired sound. This is performed in tandem while the users' lips and tongue vibrate within the mouthpiece. To be proficient, proper technique while manipulating the functional elements of the instrument is vital.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein disclose a trumpet thumb guide for aiding in proper hand position while holding a trumpet-like instrument is disclosed. The thumb guide includes a main body having a slot to receive a leadpipe of a trumpet-like instrument. A channel is positioned along a central axis of the main body to retain the leadpipe of the trumpet therein. A recessed portion promotes the ergonomic positioning of a thumb and a hand of a user while playing the trumpet-like instrument.

The thumb guide may be used as a teaching aid and training tool while playing various trumpet-style instruments such as trumpets, flugelhorns and cornets.

In one aspect, the main body is constructed of a flexible material to enable the slot to be opened to accept the leadpipe. The flexible material may be silicone or a similar material which provides a comfortable surface while playing the trumpet, as well as a material which increases the force of friction to prevent the user's hand from moving.

In one aspect, the flexible material forms a friction fit to the leadpipe to provide resistance to prevent movement of the main body while playing the trumpet.

In one aspect, the main body is positioned to enable the fingers to manipulate a plurality of valves.

In one aspect, the main body is selectively positioned on the leadpipe depending on the size of the hands of the user.

In one aspect, the channel enables the slidable engagement of the main body to the leadpipe.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the trumpet thumb guide, according to some embodiments;

FIG. 2 illustrates a perspective view of the trumpet thumb guide, according to some embodiments;

FIG. 3 illustrates a perspective view of the trumpet thumb guide, according to some embodiments; and

FIG. 4 illustrates a perspective view of the trumpet thumb guide attached to the leadpipe of a trumpet while the trumpet is being held by a user, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a trumpet thumb guide which provides a guide for use when holding and playing a trumpet. The trumpet thumb guide provides a guide to improve a musician's (i.e., a user's) technique by promoting a proper hand position and shape when playing a trumpet. The trumpet thumb guide is connected to the trumpet to ensure the user has their hand positioned in the proper location on the trumpet, leading to better tone production, increased agility, and enhanced overall performance.

Guides thumb to proper position, increasing comfort, preventing discomfort during long periods of use, and enhances the range-of-motion and overall movement of the user.

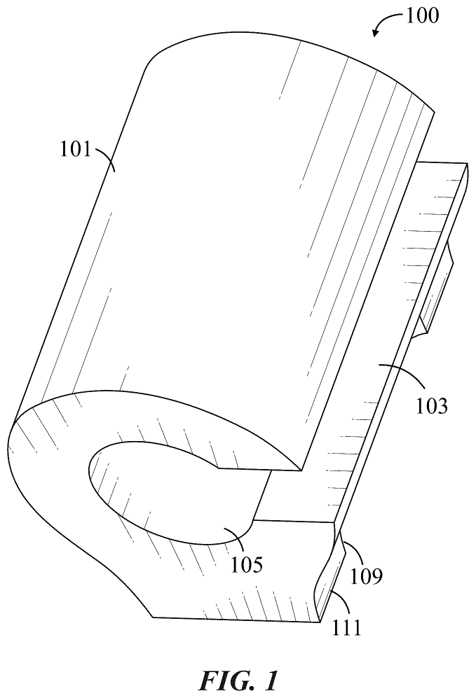

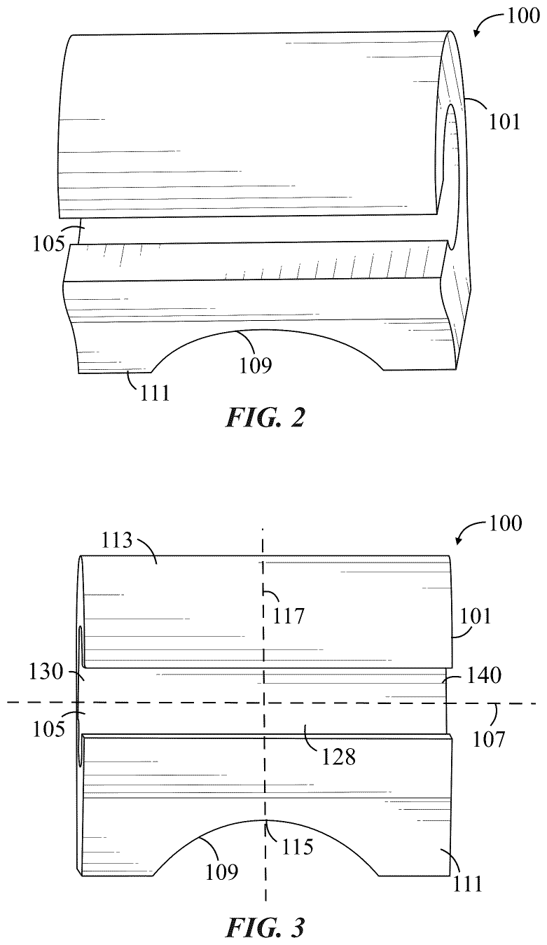

FIGS. 1-3 illustrate the trumpet thumb guide 100 which includes a main body 101 having slot 103 to receive a leadpipe of a trumpet-like instrument. A channel 105 is extends through a central axis 107 of the main body 101 to retain the leadpipe therethrough. A recessed portion 109 is molded on the exterior surface 111 of the main body 101 to promote the ergonomic positioning of the thumb and hand of a user.

The slot 128 and channel 105 extend the entire length of the trumpet thumb guide 100 to increase the friction between the leadpipe of the trumpet-like instrument to reduce the propensity of the trumpet thumb guide 100 to slide along the leadpipe while playing the instrument. In such, the leadpipe extends out of a front opening 130 and rear opening 140 (as is shown in FIG. 3) such that the channel 105 retains the trumpet thumb guide 100 in a suitable positioned on the leadpipe during use.

In some embodiments, the recessed portion 109 is configured to receive the thumb of the user while they are playing the instrument. An apex 115 (see FIG. 3) of the recessed portion 109 is along the vertical centerline 117 of the main body 101 which is advantageously positioned to enhance the user's ability to play the instrument.

In some embodiments and as shown in FIG. 3, the main body 101 is constructed of a flexible material 113 such as silicone, rubber, or similar materials. The material of the main body 101 enables the slidable engagement of the main body 101 to the leadpipe while providing sufficient resistance such that the thumb and hand are biased to a position which is beneficial when playing the trumpet-like instrument. The flexible material 113 may also be beneficial for increasing comfort, preventing discomfort and improving the user's ability to play the trumpet-like instrument.

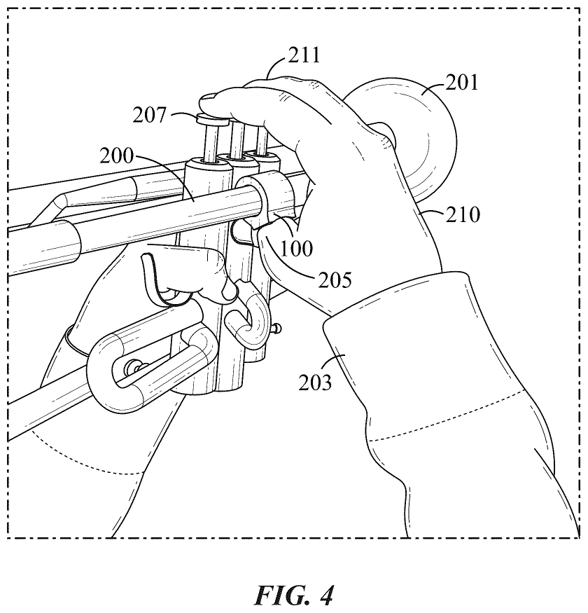

FIG. 4 illustrates the trumpet thumb guide 100 attached to the leadpipe 200 of the trumpet 201 while the trumpet 201 is being held by a user 203. The trumpet thumb guide 100 is positioned on the leadpipe 200 such that the user's thumb 205 is restricted from moving away from the recessed portion 109, thus retaining the hand 210 and fingers 211 in a suitable position for manipulating the valves 207 while playing the trumpet 201. The slot is oriented away from the user's hand while in-use, to increase comfort and to reduce the likelihood slot being opened, thus causing the trumpet thumb guide 100 to fall off or move from its preferred position during use.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A thumb guide for aiding in proper hand position while holding a trumpet-like instrument, the thumb guide comprising:
a main body including a slot to receive a leadpipe of a trumpet-like instrument;
a channel positioned along a central axis of the main body, the channel to retain the leadpipe of the trumpet-like instrument; and
a recessed portion to promote ergonomic positioning of a thumb and a hand of a user.

2. The trumpet thumb guide of claim 1, wherein the main body is constructed of a flexible material to enable the slot to be opened to accept the leadpipe.

3. The trumpet thumb guide of claim 2, wherein the flexible material increases comfort when holding the trumpet.

4. The trumpet thumb guide of claim 3, wherein the flexible material forms a friction fit to the leadpipe to provide resistance to prevent movement of the main body while playing the trumpet.

5. The trumpet thumb guide of claim 1, wherein the main body is constructed of silicone.

6. The trumpet thumb guide of claim 1, wherein the main body is positioned to enable one or more fingers to manipulate a plurality of valves.

7. The trumpet thumb guide of claim 1, wherein the main body is selectively positioned on the leadpipe depending on a hand size of the user.

8. The trumpet thumb guide of claim 1, wherein the channel enables a slidable engagement of the main body to the leadpipe.

9. The trumpet thumb guide of claim 1, wherein the trumpet thumb guide is utilized as a training tool.

10. A thumb guide for aiding in proper hand position while holding a trumpet-like instrument, the thumb guide comprising:
a main body including a slot to receive a leadpipe of a trumpet-like instrument;
a channel positioned along a central axis of the main body, the channel to retain the leadpipe of the trumpet, the slot opening to the channel to enable the leadpipe to slidably insert therein; and
a recessed portion positioned at a vertical centerline of the main body, the recessed portion to promote ergonomic positioning of a thumb and a hand of a user.

11. The trumpet thumb guide of claim 10, wherein the main body is constructed of a flexible material to enable the slot to be opened to accept the leadpipe.

12. The trumpet thumb guide of claim 11, wherein the flexible material increases comfort when holding the trumpet.

13. The trumpet thumb guide of claim 12, wherein the flexible material forms a friction fit to the leadpipe to provide resistance to prevent movement of the main body while playing the trumpet.

14. The trumpet thumb guide of claim 13, wherein the main body is constructed of silicone.

15. The trumpet thumb guide of claim 14, wherein the main body is positioned to enable one or more fingers to manipulate a plurality of valves.

16. The trumpet thumb guide of claim 15, wherein the main body is selectively positioned on the leadpipe depending on a hand size of the user.

17. The trumpet thumb guide of claim 16, wherein the channel enables the slidable engagement of the main body to the leadpipe.

18. The trumpet thumb guide of claim 17, wherein the trumpet thumb guide is utilized as a training tool.

19. The trumpet thumb guide of claim 18, wherein the main body is constructed in a cylindrical shape.

20. A thumb guide for aiding in proper hand position while holding a trumpet-like instrument, the thumb guide comprising:
a main body including a slot capable of flexing to receive a leadpipe of a trumpet-like instrument;
a channel positioned along a central axis of the main body, the channel to retain the leadpipe of the trumpet; and
a recessed portion positioned at a vertical centerline of the main body, the recessed portion to promote ergonomic positioning of a thumb and a hand of a user,
wherein the slot flexibly receives the leadpipe to enable the leadpipe to enter the channel and be retained therein, wherein the main body is constructed of a flexible material to provide sufficient resistance to prevent movement of the main body while playing the trumpet.
